(19) United States
(12) Patent Application Publication
(10) Pub. No.: US 2003/0054329 A1
(43) Pub. Date: Mar. 20, 2003

(54) Portable computer classroom with high speed two-way network access

(76) Inventor: David Roy Springett, Sacramento, CA (US)

Correspondence Address: Daniel P. Maguire, 423 E Street, Davis, CA, 95616, US

(21) Appl. No.: 09/957,950

(22) Filed: Sep. 14, 2001

(51) Int. Cl. G09B 25/00

(52) U.S. Cl. 434/373

(57) ABSTRACT

A self-contained, self-sufficient computer bus is disclosed, featuring a number of computer workstations with computers and peripherals. The computers are networked with servers that are housed on the bus, and by using a satellite internet system, the computers have broadband, two-way internet access. The bus includes a special support beam placed longitudinally inside the bus, and this beam helps secure various pieces of furniture, including the workstations themselves, cabinets, and racks to hold the servers. The bus provides its own power using a generator, although it can use local power if available.

### CROSS-REFERENCE TO RELATED APPLICATIONS

The present application is related to the patent application titled “Improved Satellite Dish Stand,” which is filed the same day as this application. The related application is not admitted to be prior art with respect to the present invention. The disclosure of that application is incorporated into this application as if set out in full.

### BACKGROUND OF THE INVENTION

1.) Field of the Invention

The present invention relates to devices and methods for providing portable access to computer and internet technology.

2.) Background of the Invention

While many in our society are enjoying the benefits of computer and internet technology, many others have no access to this technology, because of remote geography, lack of infrastructure, or poverty. To help bridge this “digital divide,” it would be desirable to provide an internet-accessible portable computer classroom, so that computer and internet technology could be brought directly to underserved areas.

However, there are a number of obstacles to the building of such a classroom. While some computers are portable, the infrastructure and peripherals that are a necessary part of modern computing are generally not. For instance, internet access has traditionally required access to a telephone or cable connection, which may not be readily available in some areas. Moreover, computer technology obviously depends on a stable, dependable power source, which is sometimes not available in rural or remote regions. Additionally, a reasonably large amount of space is required to house servers, computers printers, scanners, and other peripherals.

### BRIEF SUMMARY OF THE INVENTION

The present invention is a self-sufficient, portable, internet-accessible computer classroom or workroom. It provides all the features of modern computing, including software applications running on individual computers or servers, broadband internet access, and a wide range of peripherals, including printers, scanners, and an electronic whiteboard. It consists of a customized bus, specially adapted to contains a number of computer workstations and peripherals, as well as a power generator, a power conditioning and distribution center, cabinets for general storage and to house servers, access means to receive and send data via satellite, access means to receive external power, and air conditioning units. It also includes special beams that are bolted to the interior sides of the bus, for use in anchoring and locating the various components of the customized bus. Network and power cables are neatly housed in conduits or channels within the bus.

The present invention can work in conjunction with a specially-designed satellite dish stand. The satellite dish and its sender and receiver are part of an internet satellite system that allows two-way internet access without a land-based connection such as a telephone line or cable connection. Other parts of this system include computer servers (the system acts as its own ISP), network cables, and an satellite access computer.

### BRIEF DESCRIPTION OF THE DRAWINGS

FIG. 1 is a perspective view of a preferred version of the present invention, showing some of its features.

FIG. 2 is a perspective view of an alternative version of the present invention, showing some of its features.

FIG. 3 is a front view of a bus according to the present invention.

FIG. 4 is a rear view of a bus according to the present invention.

FIG. 5 is a side view of a bus according to the present invention.

FIG. 6 is a side view of a bus according to the present invention, from the opposite side as FIG. 5.

FIG. 7 is a floor plan of a bus according to the present invention, showing the network and satellite systems.

FIG. 8 is a floor plan of a bus according to the present invention, showing the power systems.

FIG. 9 is a floor plan of a preferred version of a bus according to the present invention, showing the placement of the furniture and other major structures.

FIG. 10 is a floor plan of an alternative version of a bus according to the present invention, showing the placement of the furniture and other major structures.

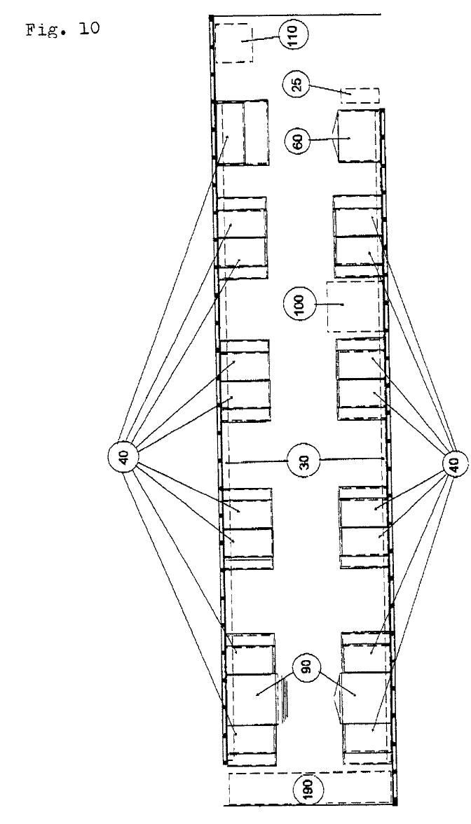

### DETAILED DESCRIPTION

The present invention is a customized bus, including support beams, workstations or countertops for placement of computers and peripherals, computer servers housed in a dedicated cabinet with racks, channeling to hold power and networking cables, storage cabinets, a generator, a power conditioning and distribution center, input and output openings for the satellite connection, a power input to receive external power, air-conditioning units, and overhead lights.

The bus, 20, is a customized version of a standard city or intercity bus. Virtually any type of bus can be used, from a small bus seating 20 passengers, to a large coach with seating for 44 or more. When suitably inspected and reconditioned, the bus can be an older vehicle near the end of its useful life, since the mileage put on the computer bus will be much less than the mileage experienced by an operating transit vehicle. Preferably, the bus will already be equipped with a lift, 25, to allow access for handicapped users. If the bus does not already have such a lift, it can be added to ensure that the bus is accessible to all. Although a bus is used in the preferred embodiment of the present invention, this invention could also be adapted to work with other vehicles.

The first step in customizing the bus is removal of existing interior features, including seats, handles, guides, etc. The driver's seat and work area are of course left intact. Once the interior cabin of the bus has been gutted, then the custom features can be installed.

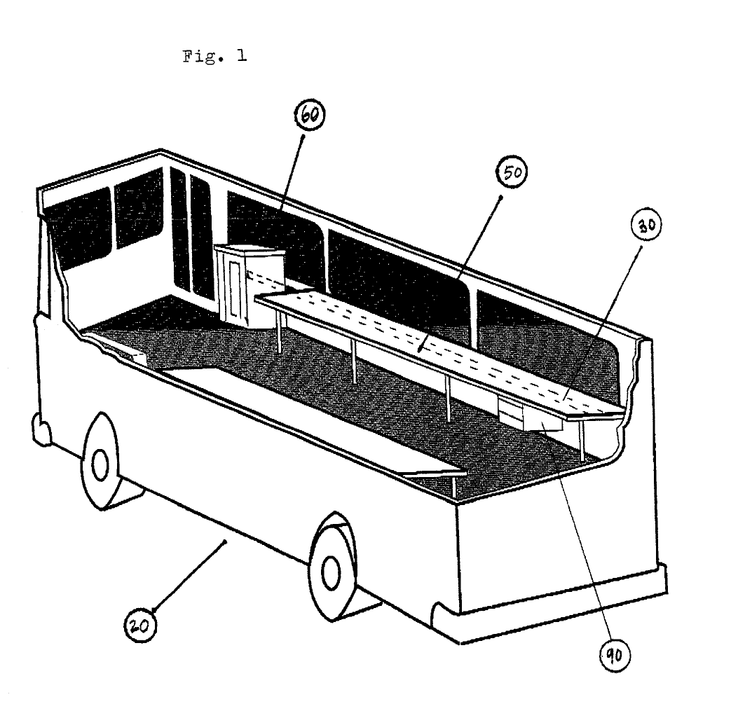

A key feature of the present invention is the set of support beams, 30, which are bolted or otherwise secured to the ribs on both sides of the interior of the bus. The location of these beams is depicted in FIGS. 1, 2, 5, 6, 9, & 10. These beams are preferably made of aluminum, although other strong, lightweight materials could be used. The purpose of the beams is to provide support for the various features of the bus, and to provide a location guide for use in customizing the bus. In a preferred embodiment of the invention, the beams run longitudinally for virtually the entire length of the bus' cabin, and are approximately 2.5 inches wide and 2.5 inches deep.

The beams help supports the desks, 40, or countertops, 50, which provide the space for computer use. (See FIGS. 1, 2, 9 & 10). The term “workstations” will be used to generically to denote desks, countertops, or other furniture that provide the work space for the computer activities.

In the preferred embodiment of the present invention, countertops, 50, are used. These countertops are long, horizontal surfaces extending virtually the length of the bus' cabin. The countertops are secured by the support beam, and also by legs extending downward from the countertops to the floor of the bus. The computer and any peripheral device rest on top of the bench, and chairs are placed facing the windows to providing seating for the users. In order to conserve space, it is preferable to use laptop computers or flat panel displays in conjunction with the countertops.

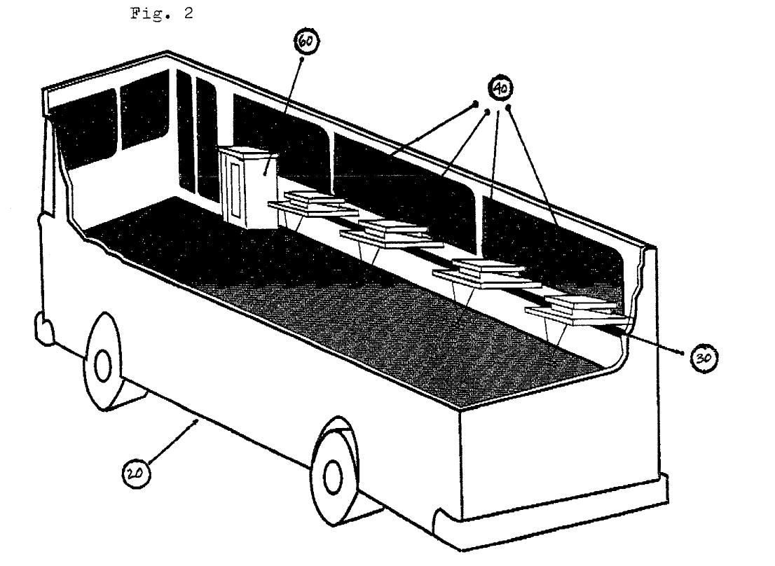

In an alternative embodiment of the present invention, desks, 40, are used instead. (See FIG. 2). The desks have two work surfaces: an upper surface that can house the computer display and also possibly the CPU, and a lower surface which holds the keyboard, and also possibly the CPU, if it is not placed elsewhere. Chairs are used to provide seating, and each desk can fit two users, who sit facing each other. Like the countertops, the desks also have legs to support them, in addition to the beams.

The workstations should be durable and attractive, and in a preferred embodiment have formica countertops with hardwood maple trim. Any variety of personal computer could be used, although the computers should be loaded with standard applications (word processing, a spreadsheet) for the benefit of new computer users.

The computers at the workstations are part of a computer network, with a set of servers at its core. These servers are housed in a server cabinet, 60, which contains racks to hold the servers. (See FIGS. 1, 2, 9, & 10). Any conventional network system can be used, although as explained below, the network is connected to the internet through a unique satellite communication system.

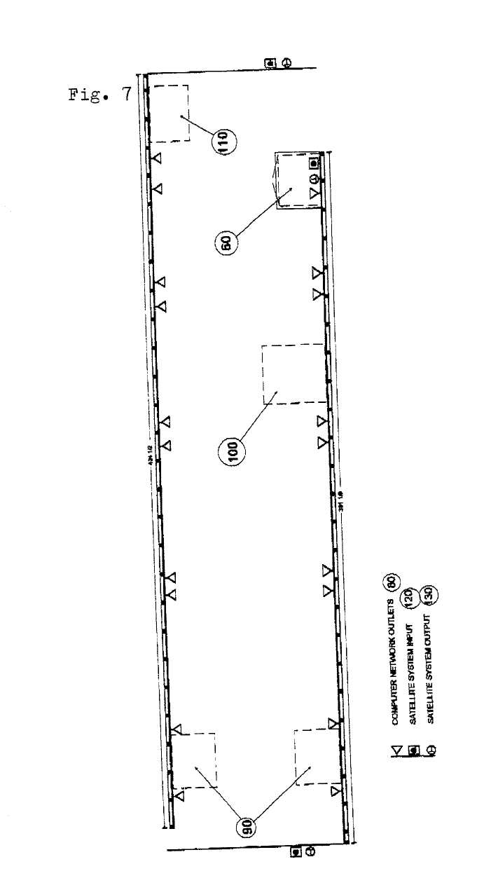

As depicted on FIG. 7, the present invention has network wiring channels that connect the server, computers, and satellite system. For part of their length, the channels can run alongside the interior side of the bus, beneath the beam, 30. These channels contains the various coaxial cables that allow the computers to communicate with the servers and with the internet. Any durable conduit can be used for the network wiring channels, although the preferred structure is wire mold. The channels can be made of plastic, composite, sheet metal or any other lightweight durable material. The channels have circuit taps along their length to provide an outlet for connection to the computer, servers, and peripherals, as illustrated in FIG. 7. Therefore, each computer can be directly connected to the servers.

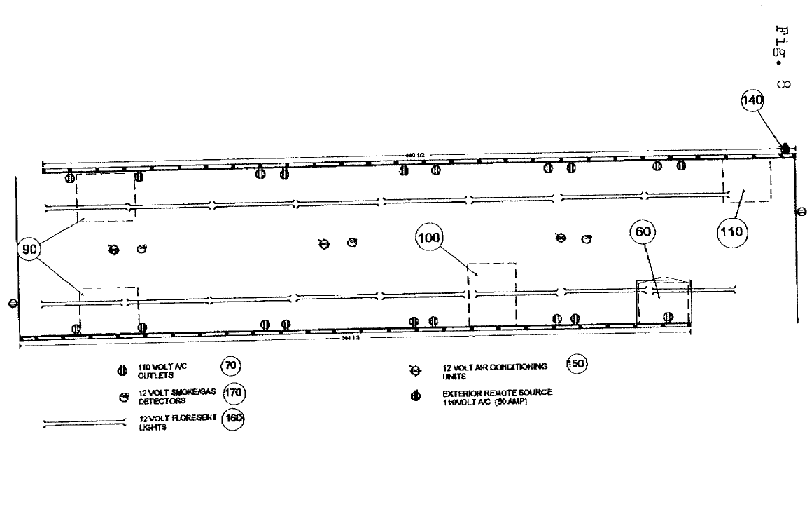

Like the networks wiring channels, the present invention has power wiring channels to distribute power and organize and conceal the power wires. As with the network wiring channels, the power wiring channels are preferably wire mold. The channels have circuit taps along their length to allow the provision of electrical power for the computers and peripherals, as illustrated in FIG. 8. There are two separate sets of power wiring channels: one for the devices running on 110 volt AC current (listed below), and one for the devices running on 12 volt DC current (also listed below).

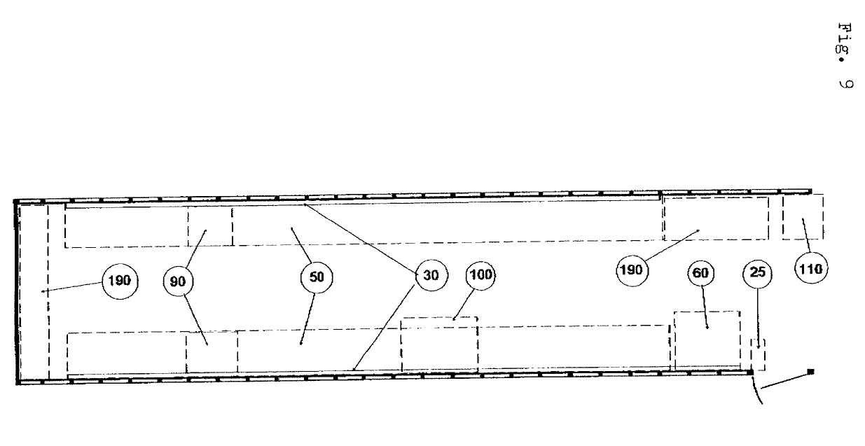

Storage cabinets, 90, are provided for general storage use, and can be used to hold training manuals and other materials used in conjunction with the computers. (See FIGS. 1, 9 & 10).

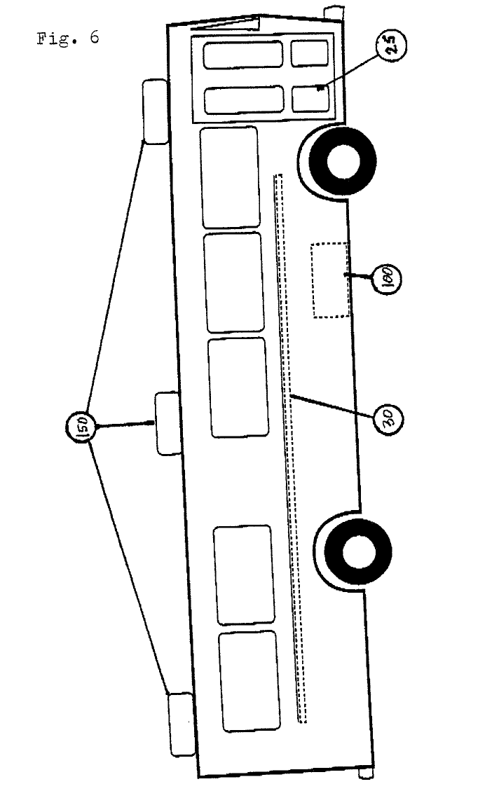

To provide electricity, a generator, 100, is placed beneath the cabin of the bus. Preferably, a conventional gas generator is used, but a diesel generator could also be used. The generator also has a fuel tank, placed beneath the cabin of the bus. The fuel tank should store enough fuel to allow for a full day's operation without refilling. In operation, the generator is started as soon as the bus is parked in the location where it will provide its services. The location of the generator is depicted on FIG. 6, 9 & 10.

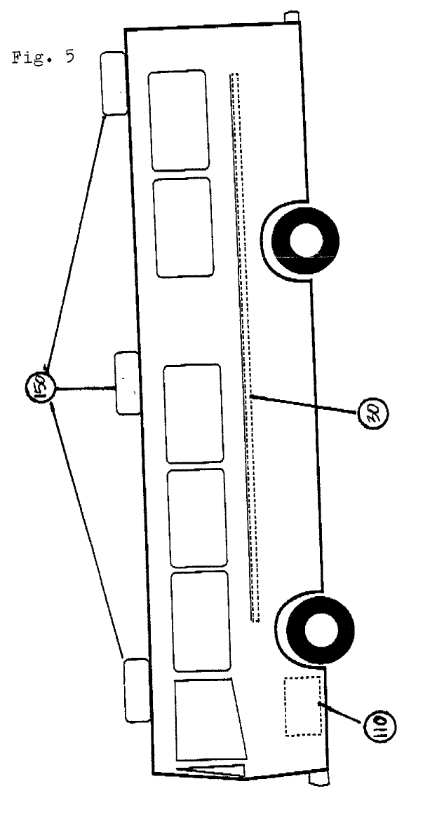

The generator is connected to a power conditioning and distribution center, 110. This center conditions the electrical current, to guard against spikes or surges that could damage the sensitive computer equipment in the bus. Using conventional converters, the center also converts the power from the generator to a 12 volt direct current, for use by the interior lights, 160, air conditioners, 150, and smoke/gas detectors, 170. The remainder of the electrical devices—including the computers, the servers, the network devices, the satellite system, and a public address system—run off a 110 volt AC current that is provided directly by the generator and then conditioned by the center. The location of this center is depicted on FIG. 5, 9 & 10.

An important part of the bus is the satellite system. This system includes a satellite dish with a sender and a receiver, a satellite stand to hold the dish, a satellite access computer that helps convert the data sent to and received from the satellite, and the servers. Except for the satellite stand, which has been developed by the owner of the present patent, and the servers, which are conventional network servers, the other parts of the satellite system have been obtained from Tachyon, Inc., 5808 Pacific Center Boulevard, San Diego, Calif.

This system allows for broadband internet access at speeds of up to 2 mb per second (incoming data), and 512 kb per second (outgoing data). Two-way access is provided, in that no land line connection is needed for either the outgoing or incoming data. The servers on the bus allow the bus to act as its own ISP, directly connecting to the internet.

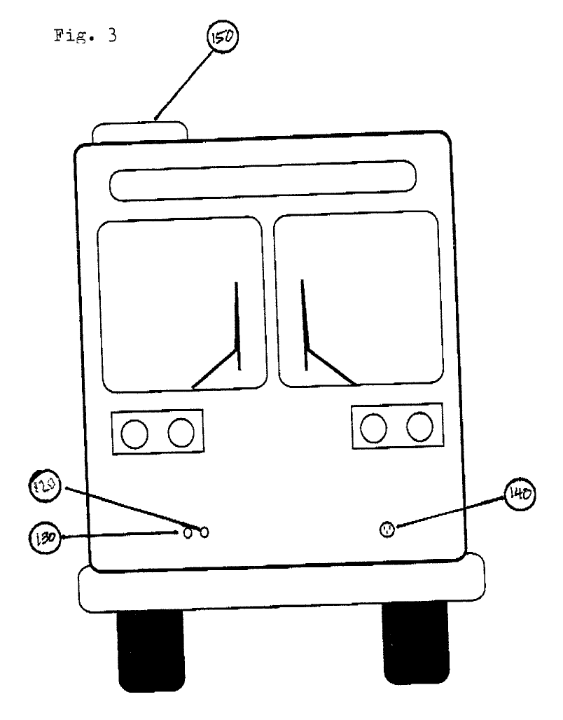

The satellite dish can be placed at either the front or rear of the bus, since satellite entry ports, 120, and satellite exit ports, 130, are provided at both ends of the bus. (See FIGS. 3 & 4). As explained in the patent for the “Improved Satellite Dish Stand,” the satellite dish is preferably supported by a unique satellite stand that has a stabilization plate that secures the stand using the weight of the bus or other vehicle.

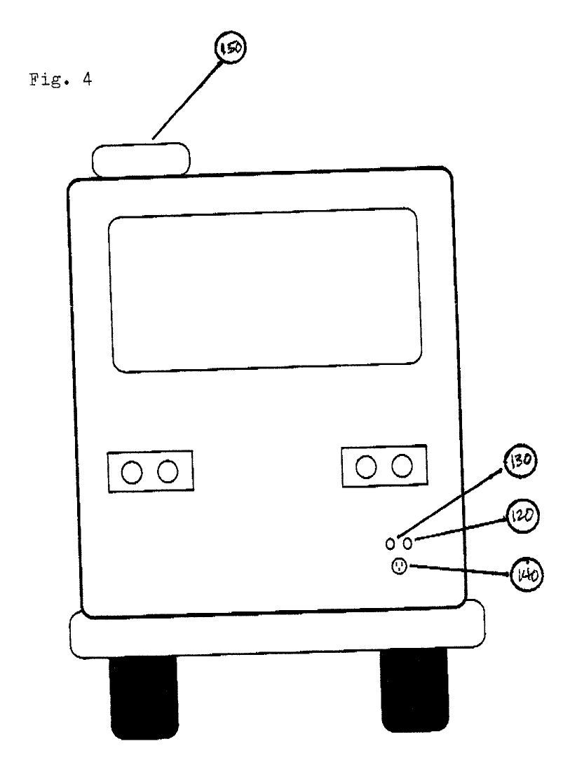

Although the bus is designed to run off the power created by the generator, the bus also has a power input port, 140, to allow it to plug into local sources. (See FIGS. 3, 4 & 8). This power input is designed to accept 50, amp., 110 volt AC current. The power system includes conventional circuitry and circuit breakers to ensure that no damage is caused if the generator is running, but someone attempts to plug into an external power source anyway.

The bus is provided with conventional top-mounted air conditioning units, 150, which may be necessary for the comfort of the users and the integrity of the sensitive electronic equipment. (See FIGS. 3, 4, 5 & 6). It has been found that three such units are sufficient for most climates

The bus is provisioned with conventional overhead lights, 160, thereby allowing the bus to be used at nighttime as well as the day. The bus also has conventional smoke/gas detectors, 170, for added safety. The location of these devices in a preferred embodiment of the present invention is shown on FIG. 8.

Finally, the bus provides passenger seating, 190, as depicted on FIGS. 9 & 10. This seating, which preferably takes the form of a standard bus bench, can be placed at both the front and rear of the bus.

I claim:

1.) A customized computer bus, comprising:
a bus;
a beam secured to the interior of said bus;
computer workstations secured to said beam; and
a two-way internet satellite system, said system providing broadband internet access to computers placed on said workstations.

2.) The customized bus according to claim 1, wherein said computers are networked within said bus using computer servers.

3.) The customized bus according to claim 2, additionally comprising a power generator, and means for conditioning the electrical power created by said generator.

4.) The customized bus according to claim 3, wherein said satellite system comprises a satellite access computer.

5.) The customized bus according to claim 4, additionally comprising channeling to house cables connecting said satellite system to said computer workstations.

6.) The customized bus according to claim 5, additionally comprising second channeling to house wires carrying electrical energy from said generator to said workstations.

7.) A method of customizing a bus to create a portable computer workplace, comprising the steps of:
removing existing interior features of the bus;
installing a beam secured to the interior of said bus;
installing computer workstations inside said bus, said workstations secured to said beam;
providing computers on said workstations; and
providing for two-way broadband satellite internet access to said computers in said bus.

8.) The method of claim 7, additionally comprising the step of providing a power generator, and providing means for conditioning electrical power created by said generator.

9.) A customized computer bus, comprising:
a bus;
a computer workstation within said bus, said workstation having a computer on it;
a two-way internet satellite system, said system providing internet access to said computer.

10.) A method of customizing a bus to create a portable computer workplace, comprising the steps of:
removing existing interior features of the bus;
installing computer workstations inside said bus;
providing computers on said workstations; and
providing for two-way broadband satellite internet access to said computers on said bus.

11.) A system for providing portable computer and internet access, comprising:
a vehicle;
computers in said vehicle; and
a satellite system in said vehicle, for providing broadband, two-way internet access to said computers.

12.) The system according to claim 11, additionally comprising a satellite dish stand that contains a stabilization plate that secures the stand using the weight of said vehicle.
